(19) United States
(12) Patent Application Publication
(10) Pub. No.: US 2025/0287867 A1
(43) Pub. Date: Sep. 18, 2025

(54) WORK-PERFORMING AERIAL VEHICLE

(71) Applicant: Kubota Corporation, Osaka (JP)

(72) Inventors: Kazuo SAKAGUCHI, Sakai-shi (JP); Kanako KONDO, Sakai-shi (JP)

(21) Appl. No.: 19/223,778

(22) Filed: May 30, 2025

Related U.S. Application Data
(63) Continuation of application No. PCT/JP2022/048216, filed on Dec. 27, 2022.

(51) Int. Cl. A01C 14/00; B64D 1/02; B64U 10/13; B64U 101/40

(52) U.S. Cl. CPC A01C 14/00; B64D 1/02; B64U 10/13; B64U 2101/40

(57) ABSTRACT

A working aerial vehicle includes an ejector including a biasing assembly configured to bias a material and a guide configured to guide the material biased by the biasing assembly in an ejection direction.

### CROSS REFERENCE TO RELATED APPLICATIONS

This application is a Continuation Application of PCT Application No. PCT/JP2022/048216 filed on Dec. 27, 2022. The entire contents of this application are hereby incorporated herein by reference.

### BACKGROUND OF THE INVENTION

### 1. Field of the Invention

The present invention relates to working aerial vehicles.

### 2. Description of the Related Art

Aerial spraying is one of methods that can improve the efficiency of seeding work and the like, and various techniques related to this have been proposed.

For example, PCT Japanese Translation Patent Publication No. JP2020-508925 discloses an aerial spraying method including a step of acquiring the wind speed of wind that causes drift dispersal of a sprayed material sprayed from an unmanned aerial vehicle (UAV), and a step of controlling one or a plurality of components of the UAV based on the acquired wind speed to at least reduce the drift dispersal.

Japanese Patent Application Laid-Open No. 2012-521989 discloses a composition including at least one coating including at least one seed and at least one wetting agent, as seed Suitable for aerial spraying.

Japanese Patent Application Laid-Open No. 2012-70681 discloses a vegetation bag for aerial seeding greening, which is aerially sprayed to capture flying seeds and green a greening target area, the vegetation bag including a vegetation base material and a bag body filled with the vegetation base material, in which a plan view shape of the vegetation bag is molded in an annular shape.

### SUMMARY OF THE INVENTION

In the aerial spraying technique in the related art, there is a case where a material sprayed from the air cannot be retained at an intended place. In addition, it was difficult to control the dispersion state of the material on the ground surface. Therefore, for example, it was difficult to realize a state in which crops were arranged in an orderly manner in the field.

In view of the above-described problems, there is a demand for realization of a working aerial vehicle in which a dispersion state of a material on the ground surface is easily controlled.

A working aerial vehicle according to an example embodiment of the present invention includes an ejector including at least one biasing assembly configured to bias a material and at least one guide configured to guide the material biased by the at least one biasing assembly in an ejection direction below an airframe, in which the ejection direction is changeable.

According to this configuration, since the material can be ejected to a desired location, it is easy to control a dispersion state of the material on the ground surface.

Hereinafter, additional example embodiments of the

present invention will be described. However, the scope of the present invention is not limited to the following additional example embodiments.

In a working aerial vehicle according to an example embodiment of the present invention, it is preferable that the at least one guide may be swingable.

According to this configuration, it is particularly easy to aim at an ejection destination of the material. In addition, the material can be ejected in various directions by a single guide.

In a working aerial vehicle according to an example embodiment of the present invention, it is preferable that the at least one biasing assembly may include a plurality of biasing assemblies, the at least one guide may include a plurality of guides, and the ejector may include the plurality of biasing assemblies and the plurality of guides and that each of the plurality of guides may be independently swingable.

According to this configuration, a plurality of materials can be simultaneously ejected to a desired location.

In a working aerial vehicle according to an example embodiment of the present invention, it is preferable that the at least biasing assembly may include a plurality of biasing assemblies and the ejector may include a plurality of biasing assemblies and that the ejector may be configured or programmed to independently control operations of the plurality of biasing assemblies.

According to this configuration, a plurality of materials can be ejected simultaneously. In addition, since the number of materials to be ejected can be optionally changed according to the situation of the ejection destination, it is easy to use the materials effectively.

In a working aerial vehicle according to an example embodiment of the present invention, it is preferable that the at least one guide includes a plurality of guides and the ejector may include the plurality of guides with different directions in which the material is guided.

According to this configuration, since it is not necessary to provide a movable portion in the at least one guide, it is easy to determine the aiming of the ejection destination.

In a working aerial vehicle according to an example embodiment of the present invention, it is preferable that the ejector may be changeable between a storage posture in which the at least one guide is stored and a deployed posture in which the at least one guide is deployed.

According to this configuration, since the storage posture is taken in a case where the material does not need to be ejected, the air resistance is relatively small. Therefore, the flight of the working aerial vehicle is easily controlled.

In a working aerial vehicle according to an example embodiment of the present invention, it is preferable that the working aerial vehicle may further include a rotor configured to generate lift, and the working aerial vehicle may be configured or programmed to specify a degree of downwash generated by the rotor and determine at least one of the ejection direction and an ejection speed of the material in consideration of the degree of downwash.

According to this configuration, since the ejected material is easily buried in the ejection destination, the material is easily held at the ejection destination.

In a working aerial vehicle according to an example embodiment of the present invention, it is preferable that the working aerial vehicle may further include an aerial vehicle separate from the ejector, and the ejector is connected to the aerial vehicle.

According to this configuration, an aerial vehicle portion can be generalized and can be shared with other works.

In a working aerial vehicle according to an example embodiment of the present invention, it is preferable that the working aerial vehicle may further include a storage configured to store the material and supply the material to the ejector.

According to this configuration, since the frequency of supplying the material can be reduced, the work efficiency is easily improved.

In a working aerial vehicle according to an example embodiment of the present invention, it is preferable that the at least one guide may include a plurality of guides and that ejection directions of each material from the plurality of guides may be controllable to be parallel or substantially parallel.

According to this configuration, since the materials are easily aligned, it is easy to perform work such as a plurality of rows of seeding.

In a working aerial vehicle according to an example embodiment of the present invention, it is preferable that the working aerial vehicle may be configured or programmed to specify a range that is a region in which a landing speed of the material is equal to or higher than a predetermined threshold value, and control a path such that a point where the material is to land is included in the range.

According to this configuration, it is easy to land the material in an appropriate state.

In a working aerial vehicle according to an example embodiment of the present invention, it is preferable that the material may be an agricultural material.

According to this configuration, a working aerial vehicle according to an example embodiment of the present invention can be preferably used for the work of supplying agricultural materials such as seeds, seedlings, fertilizers, chemicals, water, and soil to a field.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram of a working aerial vehicle according to a first example embodiment of the present invention.

FIG. 2 is a functional configuration diagram of an ejector according to the first example embodiment of the present invention.

FIG. 3 is a diagram illustrating an ejection method in the working aerial vehicle according to the first example embodiment of the present invention.

FIG. 4 is a functional configuration diagram of a modification example of the ejector according to the first example embodiment of the present invention.

FIG. 5 is a schematic diagram of a working aerial vehicle according to a second example embodiment of the present invention.

FIG. 6 is a functional configuration diagram of an ejector according to the second example embodiment of the present invention.

### DETAILED DESCRIPTION OF THE EXAMPLE EMBODIMENTS

Example embodiments of working aerial vehicles according to the present invention will be described with reference to the drawings. In the following, examples in which the working aerial vehicles according to example embodiments of the present invention are applied to working aerial vehicles 1 that perform seeding will be described.

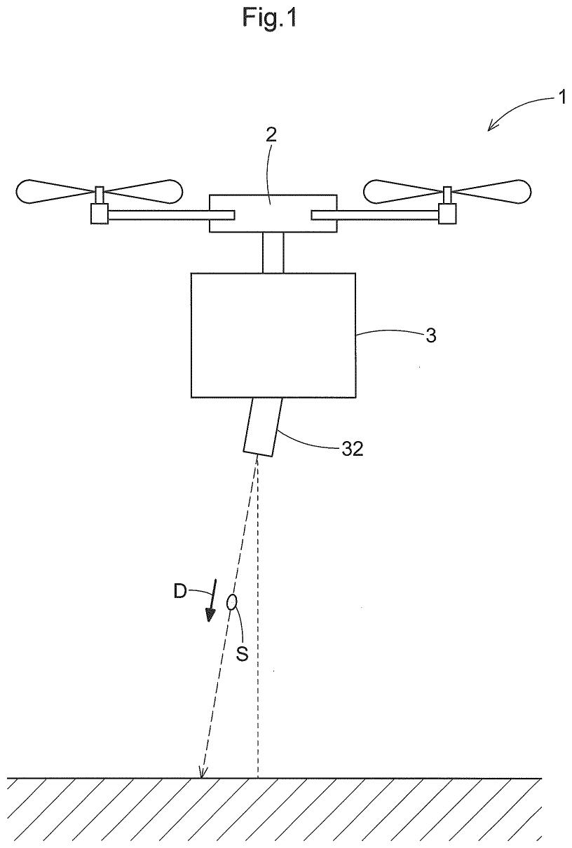

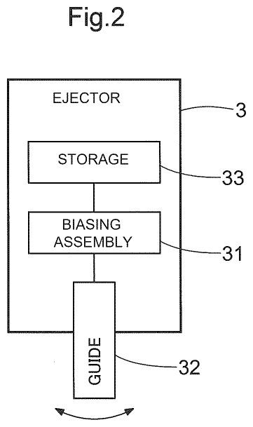

The working aerial vehicle 1 according to a first example embodiment includes an aerial vehicle 2 and an ejector 3, and the ejector 3 includes a biasing assembly 31, a guide 32, and a storage 33 (FIGS. 1 and 2). The aerial vehicle 2 and the ejector 3 are separate bodies, and the ejector 3 is attachably and detachably connected to the aerial vehicle 2. The working aerial vehicle 1 ejects a seed S (an example of a material and an example of an agricultural material) stored in the storage 33 from the air toward a field.

The biasing assembly 31 ejects the seed S toward the field. The biasing assembly 31 is preferably driven to impart sufficient kinetic energy to the seed S so that the ejected seed S can be buried in the field, and the mechanism, output, and the like of the biasing assembly 31 are selected to realize this function.

In particular, it is preferable that at least one of the ejection direction and the ejection speed of the seed S is determined in consideration of the degree of downwash generated by a rotor of the aerial vehicle 2. The ejection speed herein refers to a speed at the moment when the seed S is ejected from the ejector 3. Preferably, the path of the seed S can be changed due to the influence of the downwash, and the seed S is ejected at an ejection speed exceeding a certain level, such that the path of the seed S is controller to a level at which the influence of the downwash can be at least ignored. In addition, the ejection speed may also be determined in consideration of the dimension, the mass, and the like of the seed S as well as the wind direction, the wind speed, and the like around the working aerial vehicle 1. The control of the ejection speed can be realized by controlling the output of the biasing assembly 31.

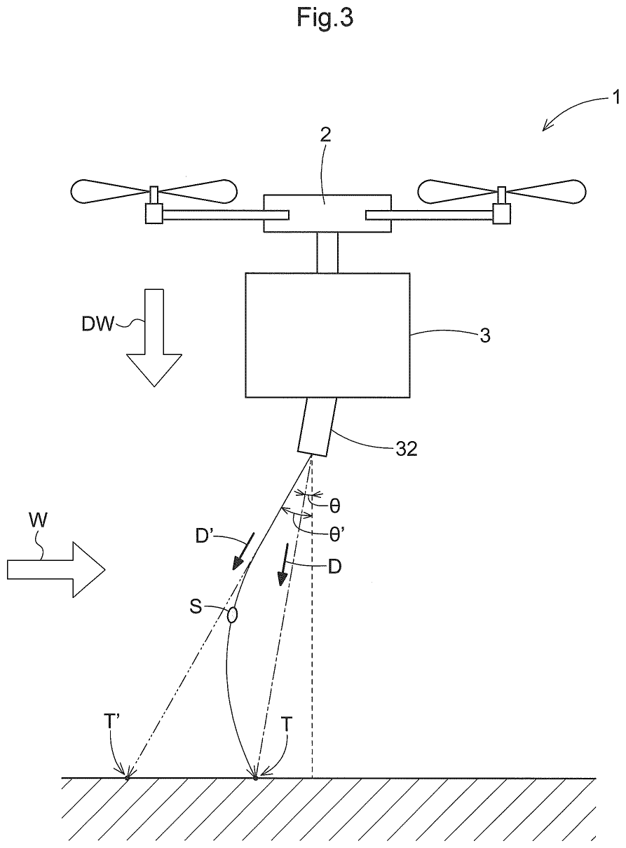

An example in which the influence of downwash and wind is considered is illustrated in FIG. 3. In the situation illustrated in FIG. 3, the seed S ejected from the ejector 3 receives a downward force due to downwash DW and a rightward force on the paper due to the wind W. Due to these influences, the path of the seed S is changed. Therefore, in a case where the seed S is ejected in an ejection direction D (ejection angle θ) that linearly approaches a target point T, the seed S lands on a position (in the example of FIG. 3, a position deviated to the right direction of the paper) deviated from the target point T. Thus, taking into consideration the direction and the degree of the downwash DW and the wind W, a virtual target point T′ is calculated such that a destination point by the path changed due to theses influences is the target point T, and the seed S is ejected in an ejection direction D′ (ejection angle θ′) that linearly faces the virtual target point T′.

Examples of a specific configuration of the biasing assembly 31 include a mechanical device that ejects the seed S by a gear rotating at a high speed, a pressurization device that ejects the seed S using a compressed fluid (for example, compressed air), and the like.

The guide 32 is a nozzle-shaped structure that guides the seed S biased by the biasing assembly 31. The biased seed S passes through a tubular guide 32, is guided in the ejection direction D below the airframe of the working aerial vehicle 1, and is ejected to the field.

The purpose of ejecting the seed S by the working aerial vehicle 1 is to control a landing point of the seed S. That is, in a case where the seed S is simply dropped from a high place, it is difficult to land the seed S at a target position due to the influence of the wind. However, in the working aerial vehicle 1 according to the first example embodiment, the seed S is biased and ejected, so that the seed S easily lands at the target position. In order to achieve this result, the ejection direction D of the seed S is directed downward of the airframe of the working aerial vehicle 1 (FIG. 1).

In addition, from the viewpoint of controlling the landing point of the seed S, it is preferable to control the positional relationship between the working aerial vehicle 1 and the landing point such that the landing speed of the seed S is equal to or higher than a certain level. Specifically, first, a region where the landing speed of the seed S is equal to or higher than a predetermined threshold value is determined in consideration of elements such as the output of the ejector 3, the dimensions and mass of the seed S, the wind direction and wind speed around the working aerial vehicle 1, and the influence of the downwash, and is specified as the range of the ejector 3. Next, it is determined whether or not a point (landing point) where the seed S is to land is included in the specified range. Here, in a case where the landing point is included in the range, the ejection of the seed S is executed. On the other hand, in a case where the landing point is not included in the range, the path of the working aerial vehicle 1 is controlled such that the landing point is included in the range.

In the first example embodiment, the guide 32 is swingable. That is, the orientation of the guide 32, which is a nozzle-shaped structure, can be changed by any driver (not illustrated) such as an electric driver or a hydraulic driver. Accordingly, the ejection direction D of the seed S can be changed.

In addition, the ejector 3 can change the posture between a storage posture in which the guide 32 is stored and a deployed posture in which the guide 32 is deployed. In the storage posture, since the air resistance is relatively small, it is easy to control the flight of the working aerial vehicle 1. In the deployed posture, the seed S can be ejected. The specific configuration of the guide 32 that can realize the posture change is not particularly limited, and the guide 32 can change the posture by a movement selected from extension/retraction, bending, swinging, and the like.

The storage 33 is a container-shaped structure that stores the seed S and supplies the seed S to the ejector 3. The configuration of the storage 33 is appropriately selected depending on the properties, shape, and the like of the seed S to be used.

As the seed S, a seed of an agricultural crop may be used as it is, or a seed obtained by subjecting an agricultural crop collected from the seed to some processing may be used. The processing performed here includes, in addition to processing in the related art, such as the processing of adding a coating for preventing seeds from being eaten by birds or animals or the processing in which seeds are accompanied by chemicals for preventing diseases of crops or fertilizers or nutrients for promoting germination, unique processing to facilitate the seeding using the working aerial vehicle 1 according to the present example embodiment, such as the processing of adding a coating to prevent the seed S from being damaged by an impact due to ejection and the processing of adding a coating (spherical shape, cylindrical shape, or the like) to enhance the directionality of the ejected seed S. In addition, the seed S in which a plurality of types of processing is performed simultaneously or sequentially may be used. In addition, a seed that has been processed in advance may be used as the seed S, or some processing may be performed in the storage 33.

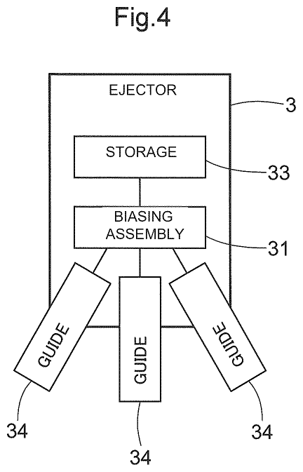

In the present example embodiment, the structures and methods for making the ejection direction D changeable are not limited to a configuration in which the guide 32 is swingable. For example, instead of the guide 32, a plurality of guides 34 having different directions in which the seed S is guided may be provided, and the ejection direction D may be changed by selectively using the guides 34 (FIG. 4). In this case, a configuration in which each guide 34 cannot swing may be adopted. In addition, even in this case, a configuration in which each of the guides 32 and 34 can change the posture between the storage posture and the deployed posture is not hindered.

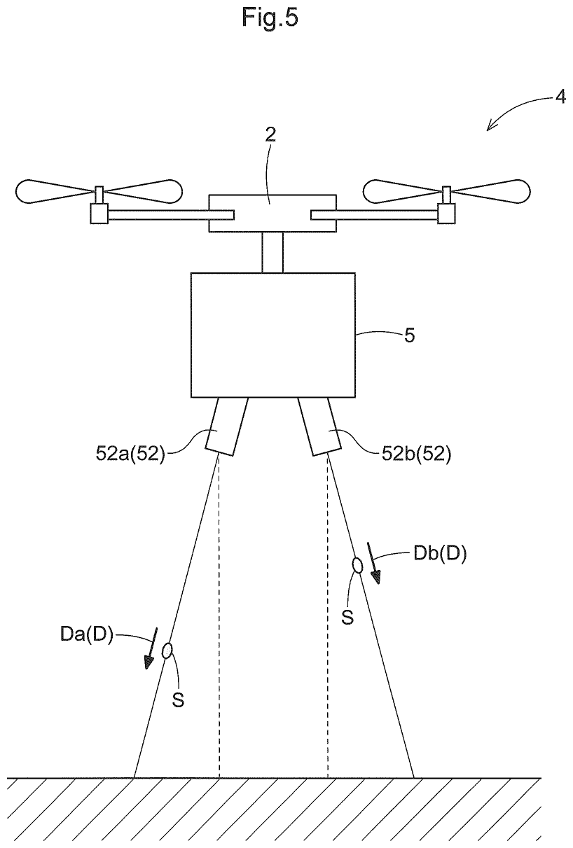

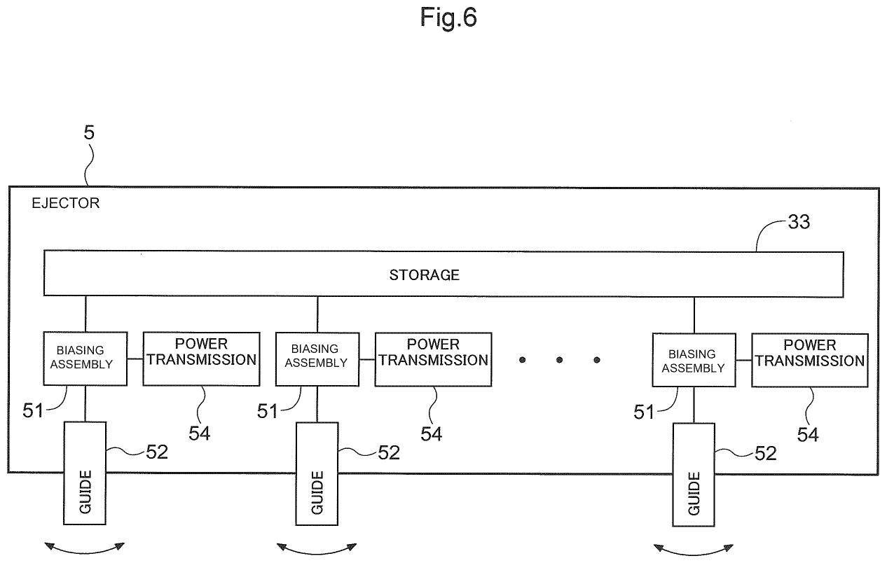

Next, a second example embodiment of the present invention will be described. The same components as those in the first example embodiment are denoted by the same reference numerals, and the description thereof will be omitted or simplified. A working aerial vehicle 4 according to the second example embodiment includes the aerial vehicle 2 and an ejector 5, and the ejector 5 includes a biasing assembly 51, a guide 52, and a storage 53 (FIGS. 5 and 6).

In the ejector 5 according to the second example embodiment, a plurality of biasing assemblies 51 are provided, and one guide 52 is connected to each of the biasing assemblies 51. The plurality of guides 52 can swing independently of each other, such that the ejection direction D of the seed S ejected from the plurality of sets of biasing assemblies 51 and guides 52 can be changed independently of each other. FIG. 4 illustrates two guides 52a and 52b representatively and illustrates a state in which the seed S are ejected in different ejection directions Da and Db.

In addition, the ejection directions D (Da, Db) of the seed S ejected from the plurality of sets of biasing assemblies 51 and guides 52 may be controlled to be parallel or substantially parallel. In this case, since the seed S is easily aligned, it is easy to perform work such as a plurality of rows of seeding. The ejection of the plurality of seeds S in a parallel or substantially parallel manner can be realized as long as at least a plurality of guides are provided.

The storage 53 is common to the plurality of sets of biasing assemblies 51 and guides 52. That is, the seed S is supplied to and ejected from each biasing assembly 51 from the single storage 53. The storage 53 may be provided for each set of the biasing assembly 51 and the guide 52. In this case, it is easy to avoid the bridge in the storage 53.

The power for the plurality of biasing assemblies 51 is supplied from a driver (not illustrated) of the aerial vehicle 2 via a power transmission 54. The power transmission 54 is provided for each of the plurality of biasing assemblies 51 and can independently select a connection state and a separation state. Accordingly, the operation of each of the plurality of biasing assemblies 51 can be independently controlled.

Other configurations of the biasing assembly 51, the guide 52, and the storage 53 are the same as the configurations of the biasing assembly 31, the guide 32, and the storage 33 in the first example embodiment, respectively.

With the working aerial vehicle 4 according to the second example embodiment, a plurality of seeds S can be ejected simultaneously in different directions. Accordingly, a plurality of rows of seeding work can be performed simultaneously. In addition, since the operations of the plurality of biasing assemblies 51 can be independently controlled, for example, operations are allowed, such as driving all the biasing assemblies 51 at a central portion of the field to perform the seeding work with a maximum number of rows and stopping some of the biasing assemblies 51 at an end portion of the field to prevent the seed S from being ejected out of the field.

Finally, other example embodiments of the working aerial vehicles according to the present invention will be described. The configurations disclosed in each of the following example embodiments can also be applied in combination with the configurations disclosed in other example embodiments as long as no contradiction occurs.

In each of the above-described example embodiments, the configuration in which the seed S is ejected has been described as an example, but the material ejected by the working aerial vehicles according to example embodiments of the present invention is not limited to the seed. Agricultural materials such as seeds, seedlings, fertilizers, chemicals, water, and soil are preferable. In addition, the working aerial vehicles according to example embodiments of the present invention may be used to eject air or the like to frighten birds and animals to exterminate the birds and animals.

In the first example embodiments described above, a configuration in which the ejector 3 can change the posture between the storage posture and the deployed posture has been described as an example. However, in the working aerial vehicles according to example embodiments of the present invention, the ejector may not be configured to change the posture.

In the second example embodiment, a configuration in which the operations of the plurality of biasing assemblies 51 can be independently controlled has been described as an example. However, in a case where a plurality of biasing assemblies are provided in the working aerial vehicles according to example embodiments of the present invention, a configuration in which the operations of the plurality of biasing assemblies is collectively controlled may also be adopted.

In the above-described example embodiments, a configuration in which the working aerial vehicle includes the aerial vehicle and the ejector separate from the aerial vehicle has been described as an example. However, the working aerial vehicles according to example embodiments of the present invention may be formed such that the aerial vehicle and the ejector are integrated together.

Regarding other configurations, it should be understood that the example embodiments disclosed in the present specification are merely examples in all points and that the scope of the present invention is not limited thereto. Those skilled in the art can easily understand that appropriate modifications can be made without departing from the spirit of the present invention. Therefore, other example embodiments modified without departing from the spirit of the present invention are also naturally included in the scope of the present invention.

Example embodiments of the present invention can be used, for example, for seeding work in a field.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working aerial vehicle, comprising:
an ejector including at least one biasing assembly configured to bias a material and at least one guide configured to guide the material biased by the at least one biasing assembly in an ejection direction below an airframe; wherein
the ejection direction is changeable.

2. The working aerial vehicle according to claim 1, wherein the at least one guide is swingable.

3. The working aerial vehicle according to claim 2, wherein
the at least one biasing assembly includes a plurality of biasing assemblies, the at least one guide includes a plurality of guides, and the ejector includes the plurality of biasing assemblies and the plurality of guides; and
each of the plurality of guides is independently swingable.

4. The working aerial vehicle according to claim 1, wherein
the at least one biasing assembly includes a plurality of biasing assemblies and the ejector includes the plurality of biasing assemblies; and
the ejector is configured or programmed to independently control operations of the plurality of biasing assemblies.

5. The working aerial vehicle according to claim 1, wherein the at least one guide includes a plurality of guides and the ejector includes the plurality of guides with different directions in which the material is guided.

6. The working aerial vehicle according to claim 1, wherein the ejector is changeable between a storage posture in which the at least one guide is stored and a deployed posture in which the at least one guide is deployed.

7. The working aerial vehicle according to claim 1, further comprising:
a rotor configured to generate lift; wherein
the working aerial vehicle is configured or programmed to specify a degree of downwash generated by the rotor and determine at least one of the ejection direction and an ejection speed of the material in consideration of the degree of downwash.

8. The working aerial vehicle according to claim 1, further comprising:
an aerial vehicle separate from the ejector; wherein
the ejector is connected to the aerial vehicle.

9. The working aerial vehicle according to claim 8, further comprising:
a storage configured to store the material and supply the material to the ejector.

10. The working aerial vehicle according to claim 1, wherein
the at least one guide includes a plurality of guides; and
ejection directions of each material from the plurality of guides are controllable to be parallel or substantially parallel.

11. The working aerial vehicle according to claim 1, wherein the working aerial vehicle is configured or programmed to specify a range that is a region in which a landing speed of the material is equal to or higher than a predetermined threshold value, and control a path such that a point where the material is to land is included in the range.

12. The working aerial vehicle according to claim 1, wherein the material is an agricultural material.
